(19) United States
(12) Patent Application Publication
(10) Pub. No.: US 2026/0117869 A1
(43) Pub. Date: Apr. 30, 2026

(54) Gasket Seal Device

(71) Applicant: Onesimo Gonzales, Abilene, TX (US)

(72) Inventor: Onesimo Gonzales, Abilene, TX (US)

(21) Appl. No.: 18/914,954

(22) Filed: Oct. 14, 2024

(51) Int. Cl. F16J 15/08; B64D 47/00; B64F 5/10

(52) U.S. Cl. CPC F16J 15/0825; B64D 47/00; B64F 5/10

(57) ABSTRACT

An aircraft gasket comprises a plurality of layers configured to fit between an external aircraft equipment and a mounting area on an aircraft. The plurality of layers substantially cover the mounting area. The plurality of layers includes at least a first layer comprised of a first flexible material and a first plurality of apertures, and a second layer comprised of a rigid material and a second plurality of apertures. The second plurality of apertures is aligned with, and larger than, the first plurality of apertures. A third layer of flexible includes a third plurality of apertures. The apertures enable the connection of the external aircraft equipment and the mounting area. The aircraft gasket forms a seal that inhibits fluid and debris from entering the external aircraft equipment at the mounting area of the aircraft.

### TECHNICAL FIELD OF THE INVENTION

This disclosure relates to aircraft structures, and, more particularly, to an improved sealing gasket and method of manufacturing and installing the same.

### BACKGROUND OF THE INVENTION

Installing a gasket seal device quickly and efficiently on an airplane is an important aspect of aircraft maintenance. Installation of the gasket seal device is often complicated by poorly fitted seals, which in turn causes the gasket seal device to go through many different fabrication shops to fit specific specifications. As a result, the price of aircraft maintenance is often substantially increased and the efficiency of airplane maintenance is drastically decreased. Prior gasket seal devices thus increase the cost and time of aircraft maintenance.

### SUMMARY OF THE INVENTION

In accordance with one aspect of the present invention, a aircraft gasket comprises a plurality of flexible and rigid layers configured to fit between an external aircraft equipment and a mounting area on an aircraft to provide a seal between the external aircraft equipment and the mounting area on the aircraft. The aircraft gasket includes a flexible material layer comprised of rubber, and a rigid material layer comprised of aluminum.

In accordance with the present invention, a “Gasket Seal Device” is provided that eliminates or reduces disadvantages and problems associated with previous gasket sealing systems and methods

In accordance with another aspect of the present invention, a method is provided for sealing an external aircraft equipment to a mounting area on an aircraft by arranging a plurality of layers configured to create a tight fit in order to keep out a variety of debris and to protect internal equipment.

### BRIEF DESCRIPTION OF THE DRAWINGS

The accompanying drawings, which are incorporated in and constitute a part of this specification, illustrate aspects and features of the disclosure and, together with the detailed description below, serve to further explain the disclosure, in which:

FIG. 1 illustrates a large elevation (side) view of an aircraft having an aircraft gasket of the present disclosure forming a seal between a pod and a pylon of the aircraft, in accordance with an embodiment of this disclosure;

FIG. 2 illustrates a cross-sectional view of the aircraft gasket forming a seal between the pod and the pylon of the aircraft of FIG. 1, in accordance with embodiments of this disclosure;

FIGS. 3a, 3b, and 3c illustrate plan views of first, second, and third layers, respectively, of an aircraft gasket, in accordance with embodiments of this disclosure;

FIG. 4 illustrates an exploded cross-sectional view of the plurality of layers of the aircraft gasket illustrated in FIGS. 3a-c, in accordance with embodiments of this disclosure;

FIG. 5 illustrates another aircraft gasket having a seal around a perimeter of the aircraft gasket, in accordance with embodiments of this disclosure;

FIG. 6 illustrates a method for sealing an external aircraft equipment to a mounting surface of an aircraft using an aircraft gasket of the present disclosure, in accordance with embodiments of this disclosure.

Further details and various aspects of the disclosure are described in more detail below with reference to the appended figures.

### DETAILED DESCRIPTION

Aspects of the presently disclosed aircraft gasket and methods of manufacturing and use thereof, are described in detail with reference to the drawings in which like reference numerals designate identical or corresponding or similar elements in each of the several views. However, it is to be understood that the disclosed devices are merely exemplary of the disclosure and may be embodied in various forms. Well-known functions or constructions are not described in detail to avoid obscuring the disclosure in unnecessary detail. Therefore, specific structural and functional details disclosed herein are not to be interpreted as limiting, but merely as a basis for the claims and as a representative basis for teaching one skilled in the art to variously employ the disclosure in virtually any appropriately detailed structure.

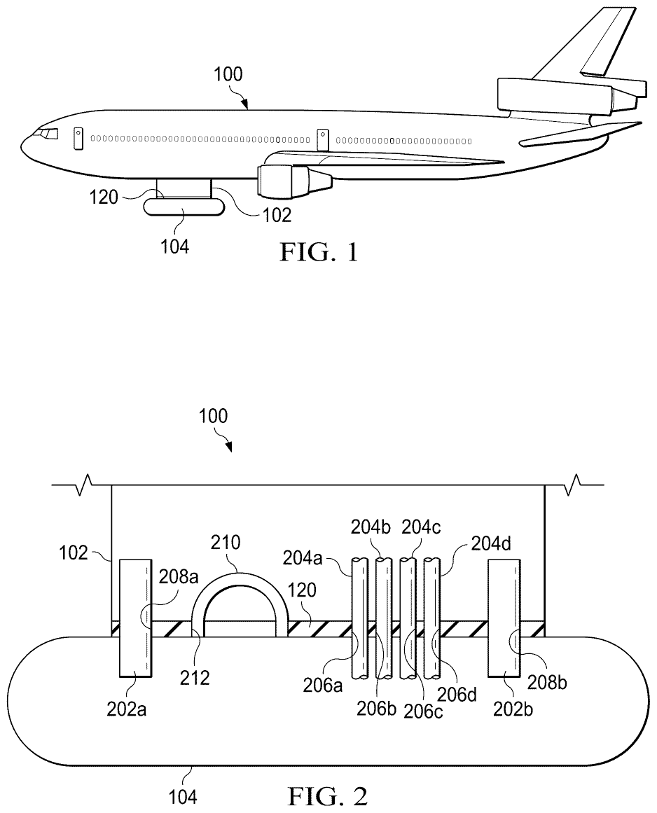

An aircraft gasket 120 is configured to couple an external aircraft equipment 104 to a mounting area 102 of an aircraft 100 as illustrated in FIG. 1. The aircraft gasket 120 is situated between a mounting area 102 and an external aircraft equipment 104 (e.g., a pod carrying surveillance equipment, a weapon system, a navigation system, an engine, a measuring device, etc.). The aircraft gasket 120 is configured to be friction fit to the mounting area 102 and the external equipment 104 to affix the aircraft gasket 120. The aircraft gasket 120 comprises a flexible and elastic material, such as, but not limited to, rubber, silicon, foam, thermoplastic elastomers, etc., surrounding a rigid core material (e.g., a metal or a carbon fiber), as will be described in more detail below.

The mounting area 102 may be situated under or on a fuselage, wing, or any other suitable mounting area of an aircraft 100. The mounting area 102 can be a pylon or any other suitable structure attached to a fuselage or surface of a fuselage for mounting an external aircraft equipment 104 and is primarily used as an attachment point for the external aircraft equipment 104. Additionally, the mounting area 102 is permanently coupled to or forms a part of the aircraft 100. The external aircraft equipment 104 can be used for a variety of different uses, including housing cameras, long-range identification equipment, continuous stabilized surveillance equipment, autonomous tracking equipment, global positioning system equipment, weapons armaments, or any other suitable equipment for military and/or civilian purposes.

The instruments housed within the external aircraft equipment 104 may be sensitive to environmental changes-protecting them from debris and fluids is important to the overall operation of the aircraft 100. The aircraft gasket 120 inhibits debris and fluids (e.g., air, water, exhaust gases, etc.) from entering the external aircraft equipment or aircraft by forming a seal between the external aircraft equipment 104 and the mounting area 102. The aircraft gasket 120 is permanently affixed to the mounting area 102 of the aircraft 100. The aircraft gasket 120 being permanently coupled to the aircraft 100 lessens or eliminates the burden of removing and re-coupling a gasket seal when providing maintenance to the external aircraft equipment 104. This is advantageous because whoever is performing maintenance on the aircraft 100 saves time because the aircraft gasket does not need to be removed or replaced at every maintenance event. Further, advantageously, the aircraft gasket 120 will last longer because it will not undergo as much wear and tear as it would if it were to be removed every time maintenance is done since the aircraft gasket 120 is permanently affixed to the mounting area.

One embodiment of the aircraft gasket 120 forming a seal between the external equipment 104 and the aircraft 100 is shown in FIG. 2. As discussed above, the aircraft gasket 120 is disposed between the mounting area 102 and the external aircraft equipment 104. The aircraft gasket 120 includes at least one support aperture (e.g., 208a) for receiving an interconnecting support post 202a. In aspects, the aircraft gasket 120 includes a first support aperture 208a and a second support aperture 208b for receiving interconnecting support post 202a and an interconnecting support post 202b. The interconnecting support posts 202a and 202b may be positioned at the fore and aft of the mounting area 102. Although FIG. 2 depicts two interconnecting support posts 202a, 202b and two channels for support apertures 208a, 208b, another embodiment of the device may also include any number of interconnecting support posts and a respective number of support apertures, (for example, one, three, four, or five channels). In some embodiments, the interconnecting support posts may be a part of the external aircraft equipment and instead be received by the mounting area 102. In aspects, the interconnecting support posts may be clips, posts, collars, nuts and bolts, turnlock fasteners, studs, or other suitable fasteners for securing the external aircraft equipment.

The aircraft gasket 120 may have one or more communication channels (e.g., a first communication channel 206a, a second communication channel 206b, a third communication channel 206c, and a fourth communication channel 206d capable of receiving cables, wires, or any other suitable connection for transmitting information. For example, the communication channels 206a, 206b, 206c, 206d may be configured to receive communication cables 204a, 204b, 204c, 204d, respectively. The interconnecting cables 204a, 204b, 204c, 204d are capable of transmitting information, including transmitting data between aircraft 100 and external aircraft equipment 104, or any other appropriate information that wires are used to transmit. The information is transmitted from the aircraft 100 through the interconnecting cables 204a, 204b, 204c, and 204d to the external aircraft equipment 104. The aircraft gasket 120 may be configured to advantageously accommodate any number of interconnecting cables (e.g., 204a, 204b, 204c, and/or 204d), making the aircraft gasket 120 versatile for use with numerous different aircraft and external aircraft equipment 104.

The aircraft gasket 120 may include a holder aperture 212 to stow a carrying mechanism 210 of the external aircraft equipment 104 within the mounting area 102. A carrying mechanism 210 for transporting external aircraft equipment 104 may be coupled to the side of the external aircraft equipment 104 closest to the aircraft gasket 120.

The aircraft gasket 120 may include any number of layers, each layer having apertures corresponding to the communication channels (e.g., 206a), support apertures (e.g., 208a), and/or holder apertures (e.g., 212). The aircraft gasket 120 includes at least one core layer surrounded by at least one sealing layer. The core layer comprises a rigid core material such as, but not limited to, aluminum, steel, or carbon fiber. The sealing layer comprises an elastic material such as rubber, silicon, and/or thermoplastic elastomers, etc., capable of compressing to form a seal.

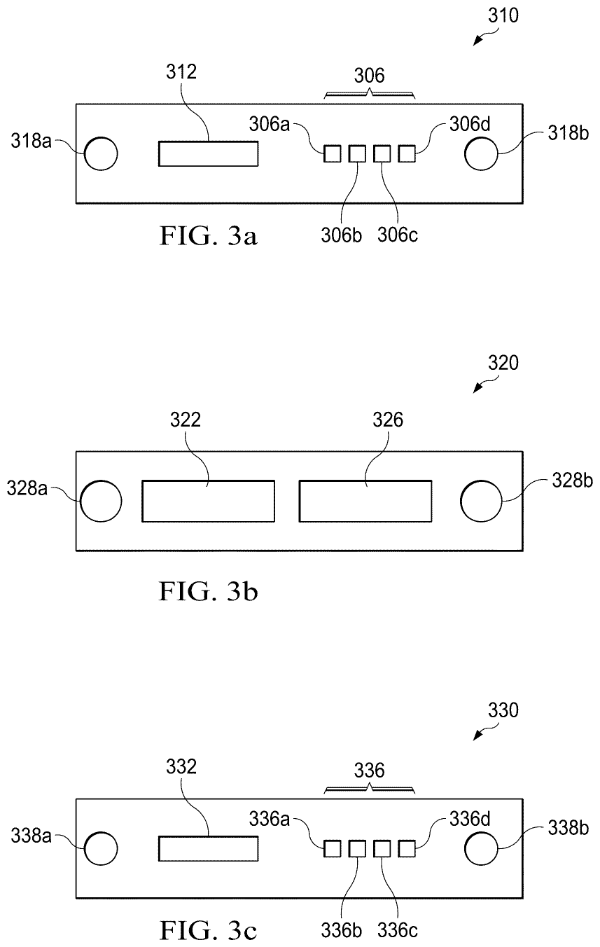

FIGS. 3a-c illustrate top-plan views of individual layers of a plurality of layers of an aircraft gasket (e.g., aircraft gasket 120) according to various embodiments of this disclosure.

FIG. 3a depicts a top plan view of a first layer 310 of the plurality of layers of the aircraft gasket 120. The first layer 310 includes a plurality of support apertures 308 include a first support aperture 318a and a second support aperture 318b. The first layer 310 further includes a plurality of communication apertures 316 including a first communication aperture 316a, a second communication aperture 316b, a third communication aperture 316c, and a fourth communication holder 316d. The first layer 310 may further include a holder aperture 312. The first layer 310 may be made from an elastic material such as rubber, silicon, thermoplastic elastomers, and similar materials known to those of ordinary skill in the art.

FIG. 3b illustrates a top plan view of a second layer 320. The second layer 320 includes one or more support apertures include support apertures 328a and 328b. The second layer 320 further includes a communication aperture 326. In aspects, the communication aperture may include a plurality of communication apertures 326 corresponding to the first, second, third, and fourth communication aperture 316a, 316b, 316c, and 316d. The first layer 310 may further include a holder aperture 322. The second layer 320 may comprise a rigid material such as aluminum, steel, plastic or carbon fiber that forms a core for the gasket sealing device 120.

FIG. 3c depicts a top plan view of a third layer 330 of the plurality of layers of the aircraft gasket 120. The first layer 330 includes a plurality of support apertures 338 include a first support aperture 338a and a second support aperture 338b. The first layer 330 further includes a plurality of communication apertures 336 including a first communication aperture 336a, a second communication aperture 336b, a third communication aperture 336c, and a fourth communication holder 336d. The first layer 310 may further include a holder aperture 332. The first layer 330 may be made from an elastic material such as rubber, silicon, thermoplastic elastomers, and similar materials known to those of ordinary skill in the art.

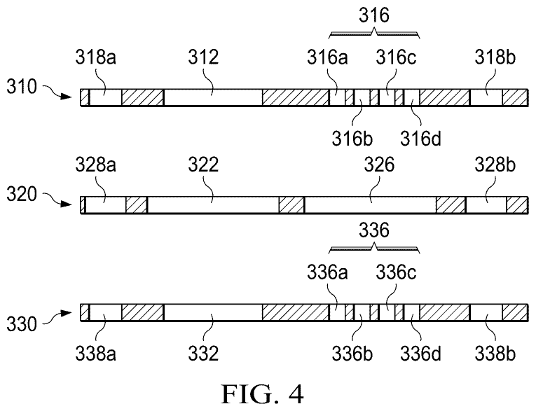

As illustrated in FIG. 4, the first layer 310 and the third layer 330 surround the second layer 320 in an overlapping alignment arrangement such that the pluralities of support apertures 318 and 338 are in alignment with each other and the support apertures 328 of the second layer 320. Similarly, the communication apertures 316 and 336 are in alignment with each other and communication aperture 326 so as to form respective channels (e.g., communication channels 206). The communication aperture 326 may be larger than the communication apertures 316 and 336 such that the clastic material (e.g., rubber) of the first and second layers abut each other at communication apertures 316 and 336. Similarly, support aperture 326 and holder aperture 322 may each be larger than support apertures 318, 338, and holder apertures 312, 332 such that the elastic material (e.g., rubber or silicon) of the first and third layers 310, 330, abut each other. In further detail, the first plurality of apertures of the first layer and the third plurality of apertures of the third layer define smaller apertures than the second plurality of apertures of the second or core layer. This advantageously may further ensure a proper seal when the aircraft gasket is used for different external aircraft equipment with different-sized cables, support posts, and carrying mechanisms.

The various apertures of the first, second, and third layers 310, 320, and 330, respectively, may be of any shape (circular, square, triangular, etc.) or size as needed to accommodate cables, support posts, and other devices, protrusions, or accessories of the external aircraft equipment. In other aspects, layers may be added (or removed) create a larger or smaller stack of layers depending on the gap that needs to be sealed by the aircraft gasket 120. For example, there may be five layers with alternating rigid and core materials. In some aspects there may be two core rigid materials (e.g., metal) adjacent each other and surrounded by layers of clastic materials (e.g., rubber).

In aspects, the third layer 330 may be made out of a more elastic flexible material than the first layer 310, which is also made out of flexible material. Advantages of the first and third layer being made of flexible material are that the aircraft gasket 120 is capable of being compressed in order to accommodate a variety of different scalable areas. Further, the flexible material absorbs much of the vibration that may be caused by the aircraft 100 during operation which helps protect the sensitive instruments contained within the external aircraft equipment 104 from being disrupted by the extreme vibrations.

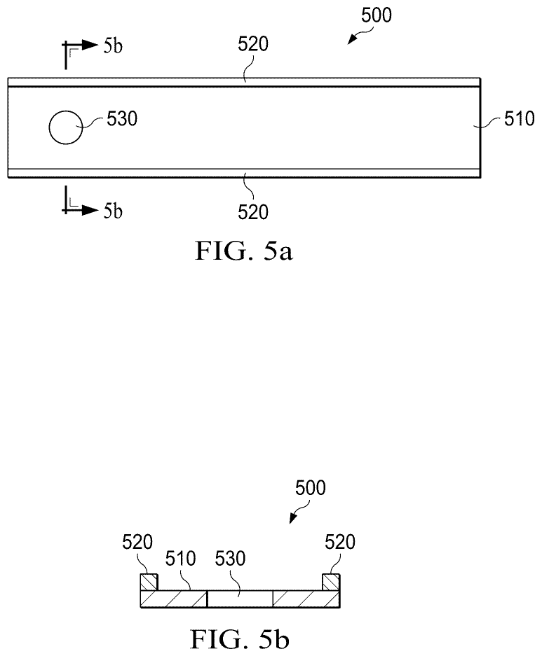

Another embodiment of an aircraft gasket 500 is shown in FIGS. 5A-B, and includes a base layer 510 and a perimeter layer 520 that is comprised of a flexible, elastic material for forming a seal around the perimeter of the aircraft gasket 500 and the mounting area. The perimeter layer 520 may comprise a rubber, thermoplastic elastomer (foam), silicon, or other similar, suitable material. The perimeter layer 520 may be disposed about one or more perimeter edges of the first layer. In aspects, another perimeter layer be disposed on the opposite side of the aircraft gasket 500 for forming a seal between the aircraft gasket 500 and the external aircraft equipment. In aspects, the perimeter layer is only disposed on a face of the aircraft gasket adjacent the external aircraft equipment.

The aircraft gasket 500 may include a one or more apertures 530 for receiving at least one of a support post, communication cable, or carrying mechanism of an external aircraft equipment. For example, the aperture 530 may be configured to receive a support post and communication cables. The base layer 510 may comprise of one or more layers of elastic and/or rigid materials.

In general, the aircraft gaskets of this disclosure are held in place by compression when the external aircraft equipment is coupled to the mounting area of an aircraft. In some aspects, an adhesive material may be disposed on a face of the aircraft gasket 120 or 500 that abuts the mounting area to facilitate additional adhesion of the aircraft gasket 120 or 500 to the aircraft. The various apertures of the aircraft gasket described herein may be sized to friction fit with corresponding support posts, cables, or carrying mechanisms to further affix the aircraft gasket in place.

In another embodiment of this disclosure, an aircraft gasket includes at least one layer of a flexible material such as, but not limited to, rubber, silicon, or a thermoplastic elastomer, and no rigid core layer comprising at least one of a metal alloy (such as aluminum, steel, etc.) or carbon fiber. In further such embodiments, the aircraft gasket be fit to the applicable aircraft or external aircraft equipment when the aircraft gasket is to be installed. The various apertures and channels may be cut on site by, for example, a maintenance technician. The layers of these various embodiments may be made of different flexible materials or the same flexible material.

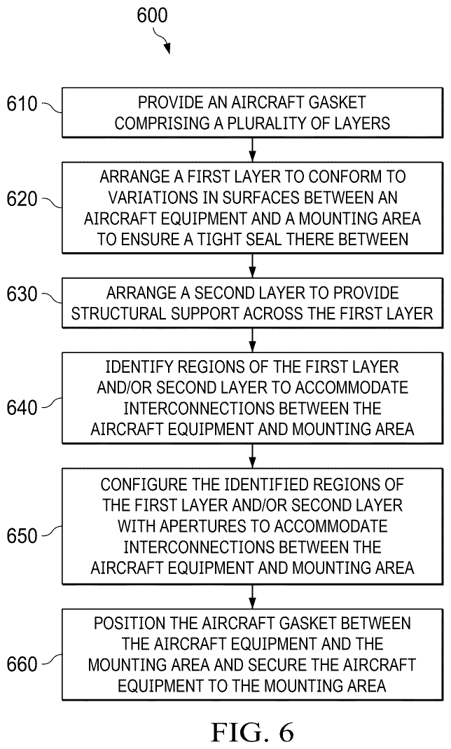

FIG. 6 represents a method 600 for providing the overall functionality of the aircraft gasket 120. The method depicted is a method for sealing a piece of aircraft equipment to a mounting area on an aircraft. The steps of the method 600 may be performed in various orders to facilitate sealing an external aircraft equipment to a mounting area using an aircraft gasket of this disclosure. Step 610 involves providing an aircraft gasket (e.g., aircraft gasket 120 or 500, with or without pre-configured apertures) composed of a plurality of layers, each layer being configured to fit between the external aircraft equipment and the mounting area on the aircraft, wherein the gasket seal device is designed to substantially cover the mounting area. Step 620 involves arranging a first layer within the plurality of layers, wherein the first layer is made of a flexible material, to conform to variations in the surfaces between the aircraft equipment and the mounting area, ensuring a tight seal. Then, step 630 involves incorporating a second layer within the plurality of layers, wherein the second layer is made of a rigid material to provide structural support across the aircraft gasket. Step 640 requires identifying one or more regions of the aircraft gasket that do not require a rigid layer, based on the need to accommodate specific interconnections between the aircraft equipment and the mounting area. Step 650 involves configuring the aircraft gasket such that the identified regions without a rigid layer correspond to areas that interconnect the aircraft equipment and mounting area across the device, ensuring that flexibility is maintained where necessary for equipment integration. Step 660 entails applying the gasket seal device between the external aircraft equipment and the mounting area, ensuring that the layers are correctly aligned and the specified regions without a rigid layer align with the interconnecting areas, to achieve an effective seal and integration between the aircraft equipment and the aircraft structure.

While FIG. 6 depicts one method for sealing a piece of aircraft equipment to a mounting area on the aircraft, there are also additional suitable methods that do not depart from the spirit of this disclosure. For example, a roll of an aircraft gasket having multiple layers, as detailed above, be provided without apertures, or only one aperture, and additional apertures thereafter cut into the aircraft gasket seal as needed so as to fit various aircraft, mounting areas, and external aircraft equipment without having to prefabricate individual aircraft gaskets. In other examples, multiple pre-fabricated aircraft gaskets may be provided and stacked as needed to create an efficient seal as determined by the needs of the aircraft and external aircraft equipment. In a further example, when a gap between an external aircraft equipment and a mounting area when coupled together is twice the depth of a aircraft gasket of this disclosure, two aircraft gasket gaskets of this disclosure may be stacked together to ensure a sufficient seal between the external aircraft equipment and the mounting area.

Advantages of the aircraft gasket of this disclosure includes reducing vibration between the aircraft and mounted equipment, reducing wear of interfacing components of the aircraft and mounted equipment, and/or reducing the transfer of fluids or other contaminants between the aircraft and mounted equipment. Furthermore, because the aircraft gasket incorporates an elastic material such as silicone or rubber in the flexible layer and a metal alloy such as aluminum in the rigid layer, there is substantial structural stability and sealing capability versus previous seals used between external aircraft equipment and a mounting area.

Although the present disclosure has been described in detail, it should be understood that various changes, substitutions, and alterations can be made without departing from the spirit and scope of the invention as defined by the appended claims.

What is claimed is:

1. An aircraft gasket comprising:
a plurality of layers configured to fit between an external aircraft equipment and a mounting area on an aircraft and substantially cover the mounting area, the plurality of layers including:
a first layer comprised of a first flexible material and a first plurality of apertures; and
a second layer comprised of a rigid material and a second plurality of apertures;
wherein the second plurality of apertures is aligned with, and larger than, the first plurality of apertures.

2. The aircraft gasket according to claim 1, wherein the first flexible material is at least one of silicon, rubber, or thermoplastic elastomer.

3. The aircraft gasket according to claim 1, wherein the rigid material is a metal alloy or carbon fiber.

4. The aircraft gasket according to claim 1, the plurality of layers including a third layer comprised of a second flexible material.

5. The aircraft gasket according to claim 4, wherein the second flexible material is more elastic than the first flexible material of the first layer.

6. The aircraft gasket according to claim 4, wherein the third layer includes a third plurality of apertures in overlapping alignment with the first and second plurality of apertures.

7. The aircraft gasket of claim 6, wherein the first plurality of apertures and the third plurality of apertures define smaller apertures than the second pluralities of apertures.

8. The aircraft gasket according to claim 4, wherein at least one of the first plurality of apertures or second plurality of apertures is configured to form a friction fit with at least one interconnection component of the external aircraft equipment.

9. The aircraft gasket according to claim 1, further comprising a perimeter layer configured to form a seal between the mounting area and the first layer.

10. The aircraft gasket according to claim 1, wherein the first plurality of apertures includes at least one of a support aperture, a communication aperture, or a carrying mechanism aperture, and the second plurality of apertures includes at least one of a corresponding support aperture, a corresponding communication aperture, or a corresponding carrying mechanism.

11. The aircraft gasket of claim 1, wherein the first layer is configured to be affixed to a mounting area by pressure exerted by a coupling mechanism for securing the external aircraft equipment to the mounting area.

12. The aircraft gasket according to claim 1, wherein the first plurality of apertures includes a support post aperture.

13. The aircraft gasket according to claim 1, wherein at least one aperture of the first plurality of apertures and at least one aperture of the second plurality of apertures are in overlapping alignment with each other and are configured to form a channel, the channel configured to receive a support post connecting the external aircraft equipment to the mounting area.

14. An aircraft gasket comprising:
a core layer comprising a rigid material including at least one of a metal alloy or carbon fiber;
an elastic material surrounding the core layer, the elastic material configured to form a seal;
a support aperture defined by the core layer and the elastic material, the support aperture configured to receive a support post for securing an external aircraft equipment to an aircraft such that, when received by the support post, the core layer and the elastic material are affixed to the aircraft by friction fit between the support aperture and the support post.

15. The aircraft gasket of claim 14, further comprising a communication channel defined by the core layer and the elastic material for receiving a communication cable.

16. The aircraft gasket of claim 14, further comprising a holder aperture defined by the core layer and the elastic material for receiving a holder of an external aircraft equipment.

17. The aircraft gasket of claim 14, wherein at least one side of the elastic material includes an adhesive.

18. The aircraft gasket of claim 14, wherein the core layer defining the support aperture is larger than the elastic material defining the support aperture such that elastic material on opposite sides of the core layer are in direct contact along an edge of the support aperture.

19. A method for providing a seal for an external aircraft equipment to a mounting area on an aircraft, comprising the steps of:
arrange a first layer over a second layer to form a gasket and a third layer on an opposite side of the second layer, the first layer and the third layer each made of a flexible material to conform to variations in surfaces between the external aircraft equipment and the mounting area, and the second layer made of a rigid material to stabilize the first layer;
identify a first region of the gasket to correspond with a support post for connecting the external aircraft equipment to the mounting area;
define a first aperture within the first region of the gasket, the first aperture defining an opening sufficient to form a friction fit with the support post.

20. The method of claim 19, further comprising:
defining a communication channel through the first, second, and third layers for facilitating connection of a communication component.
